(19) United States
(12) Patent Application Publication
(10) Pub. No.: US 2006/0188618 A1
(43) Pub. Date: Aug. 24, 2006

(54) Food composition contain lecithin

(76) Inventors: John Van De Sype, Semmerzake (BE); Marc Heirman, Kortrijk (BE)

Correspondence Address: CARGILL, INCORPORATED, LAW/24, 15407 MCGINTY ROAD WEST, WAYZATA, MN, 55391, US

(21) Appl. No.: 10/564,495

(22) PCT Filed: Jul. 24, 2003
(86) PCT No.: PCT/US03/23307

§ 371 Date: Jan. 12, 2006

(51) Int. Cl. A23L 2/00

(52) U.S. Cl. 426/330.6

(57) ABSTRACT

There are disclosed food compositions having specific lecithin products.

### CROSS REFERENCE TO RELATED APPLICATION

This application is a continuation-in-part application of U.S. application Ser. No. 10/202,294 that was filed with the United States Patent and Trademark Office on Jul. 23, 2002.

### FIELD OF THE INVENTION

The present invention relates to food compositions containing specific lecithins.

### BACKGROUND OF THE INVENTION

Food compositions suitable for frying are well known. Examples of such food compositions are butter, margarine, including liquid margarine, shortening, spreads, such as low fat spread, and cooking milk.

When used in frying, the spattering performance of the food composition is important. Spattering during flying should be avoided as much as possible. Spattering of a water-in-oil emulsion is believed to be caused by superheating of water droplets. At a certain point after heating the water droplets explosively evaporate, whereby the water-in-oil emulsion can be spread all over the surroundings of a frying pan in which the emulsion is heated.

Lecithin is well known to have an anti-spattering effect. Therefore, the improvement of spattering performance is an important reason for incorporation of lecithin in food compositions.

### SUMMARY OF THE INVENTION

The food compositions according to the invention may be water-in-oil emulsions, oil-in-water emulsions, or may substantially consist of fat or oil. The present invention relates to a food composition comprising from about 10.0 wt. % to about 100.0% fat phase, from about 0 wt. % to about 90.0 wt. % aqueous phase, and from about 0.05 wt. % to about 5.0 wt. % of the lecithin products of the present invention. The lecithin products of the present invention are in a first embodiment described as membrane separated lecithin having a ratio of alkali metals to alkaline earth metals ranging from greater than 0 to about 10, preferably from greater than 0 to about 5. In another embodiment, the lecithin products of the present invention are described as having a ratio of alkali metals to alkaline earth metals ranging from about 1.6 to about 3.0, preferably from about 1.8 to about 2.8. The fat phase may comprise any vegetable and/or animal oil or fats, natural or modified by interesterification, hydrogenation, fractionation, and the like. The frying properties of the food composition of the present invention are improved by reducing the spattering that occurs when the food composition is used for frying.

### DETAILED DESCRIPTION OF THE INVENTION

The food compositions according to the invention may be water-in-oil emulsions, oil-in-water emulsions, or may substantially consist of fat or oil. The present invention relates to a food composition comprising from about 10.0 wt. % to about 100.0% fat phase, from about 0 wt. % to about 90.0 wt. % aqueous phase, and from about 0.05 wt. % to about 5.0 wt. % of the lecithin products of the present invention. The lecithin products of the present invention are in a first embodiment described as membrane separated lecithin having a ratio of alkali metals to alkaline earth metals ranging from greater than 0 to about 10, preferably from greater than 0 to about 5. In another embodiment, the lecithin products of the present invention are described as having a ratio of alkali metals to alkaline earth metals ranging from about 1.6 to about 3.0, preferably from about 1.8 to about 2.8. The fat phase may comprise any vegetable and/or animal oil or fats, natural or modified by interesterification, hydrogenation, fractionation, and the like. The frying properties of the food composition of the present invention are improved by reducing the spattering that occurs when the food composition is used for frying.

The food composition of the present invention can be produced by any known methods. For example, a fat phase is prepared comprising an oil and a lecithin product of the present invention. The fat phase is optionally mixed with an aqueous phase. This mixture is cooled to produce the food composition of the present invention.

In the present food composition, the fat phase of about 10 to about 100 wt. % of any oil is used. In particular, the fat phase of about 60 wt. % to about 90 wt. % is suitable for use. Any oil, which may be solid or liquid at ambient temperature, can be used in the present food composition. Suitable vegetable oils for use include, for example, soybean oil, sunflower oil, rapeseed oil, cottonseed oil, olive oil, corn oil, ground nut oil, safflower oil, linola oil, linseed oil, palm oil, coconut oil, all of which may be partially or completely hydrogenated or modified otherwise, and mixtures thereof. Particularly useful are soybean oil and partially hydrogenated soybean oil. Suitable oils of animal origin for use include, for example, butterfat and fish oil.

In addition to the above-mentioned ingredients, the fat phase may optionally contain further fat-soluble ingredients. Examples of these materials are colorants, fat-soluble flavors and vitamins, mono- and/or diglycerides, etc.

The optional aqueous phase of the food composition may comprise water and optionally contain further water-soluble ingredients suitable for use. Examples of these materials are proteins, flavors, emulsifiers, thickeners, salt, dairy ingredients, preservatives, etc.

In the present food composition, about 0.05 wt. % to about 5.0 wt. % of a lecithin having an acetone soluble content of about 35 wt. % to about 40 wt. % and a ratio of greater than 0 to about 10 of alkali metals to alkaline earth metals, is used. In particular, a membrane-separated lecithin having a ratio of 2.2 alkali metals to alkaline earth metals is used.

The lecithin products of the present invention are in a first embodiment described as membrane-separated lecithin having a ratio of alkali metals to alkaline-earth metals ranging from greater than 0 to about 10, preferably 0 to 5. In a second embodiment the lecithin products of the present invention are described as lecithins having a ratio of alkali metals to alkaline-earth metals ranging from about 1.6 to about 3.0, preferably about 1.8 to about 2.8.

In determining the content of the alkali metals and alkaline earth metals of the lecithin product, the following test procedure is used:

Elemental Analysis Standard Procedure SRC

Elemental analysis was performed by Inductively Coupled Plasma-Emission Spectroscopy (ICP-ES) with target elements of aluminum, calcium, chromium, iron, lead, magnesium, nickel, potassium, phosphorus, silicon, sodium, and zinc. This analysis was performed according to the American Oil Chemists' Society (AOCS) Official Method Ca 20-99. Each sample was weighed on an analytical balance to the nearest 0.0001 g. Because of the range of concentration, two dilution levels are required. Approximately 0.8 g of sample was weighted out and recorded. To the sample approximately 4.2 g of kerosene was weighted and recorded. The sample/kerosene mixture was vortexed until the sample is completely dissolved. Approximately 4.2 g mineral oil was added to the sample/kerosene solution and recorded. This concentration is used to analyze the lower level elements, Al, Cr, Fe, Pb, Na, Ni, Si, and Zn. For the higher concentration elements, Ca, Mg, P and K, another dilution is made by taking approximately 0.5 g of the first dilution, recording the weight, and adding approximately 9.5 g of a 50/50 kerosene/mineral oil and record the total weight. All of the final dilutions are mixed until homogeneous. The samples are placed into a heated, 40° C., sample hot plate along with the standards and allowed to come to temperature, approximately 10 minutes, prior to the introduction into the ICP. Samples were run in triplicate.

Calculation:

The ICP data is reported typically as ppm calcium, magnesium, potassium, sodium and phosphorous, along with other metals. The ppm values are divided by the atomic weight of the respective element (Ca:40, K:39, P:31 and Mg:24) and the atomic equivalents are used to calculate the ratio of monovalent to divalent (alkali metals to alkaline-earth metals).

The lecithin products of the present invention may be prepared by any suitable manner. For example, a vegetable oil miscella may be passed through a membrane, preferably polymeric or semi-permeable, to obtain a retentate and a permeate. The lecithin products are in the retentate. Exemplary of such methods are those appearing in U.S. Pat. No. 6,207,209 to Jirjis, et al.; U.S. Pat. Nos. 4,496,498 and 4,533,501 to Sen Gupta. Specific examples describing the preparation of lecithin products of the invention are provided as follows:

### EXAMPLE A

Two samples of miscella were prepared by using the present technique. Miscella samples were obtained from two different oil seeds plants.

A membrane was conditioned and used for removing phospholipids from each of the two samples of miscella. The membrane purchased was a PAN membrane from Osmonics, Inc. The membrane can be characterized as having an average pore size of 0.3 micron, and in the form of a spiral wound 25 inch×40 inch membrane element. The membrane was conditioned by soaking the membrane in an intermediate solvent (propanol) for 24 hours. Then the membrane was soaked in mixture of intermediate solvent (propanol) and extraction solvent (hexane) for 24 hours. Finally, the membrane was soaked in extraction solvent (hexane) for 24 hours.

The two samples of miscella were individually processed. For the soybean oil miscella, the test was conducted at retentate concentration of 10× of the feed concentration and the permeate rate of 10× concentration was 100 liter/hour m². For the corn miscella, the test was conducted at retentate concentration of 7.4× of the feed at a permeate rate of 80 liter/hour m².

### EXAMPLE B

Samples of soybean oil miscella were taken on different days and were treated by using the present technique.

Spiral wound 8 inch×40 inch QX membranes were purchased from Osmonics, Inc. The membranes were conditioned and used for removing phospholipids by soaking them in an intermediate solvent (100% isopropanol) for 12 hours. At 6 hours, the intermediate solvent was recirculated at a flow rate of 15 m3/hr per element and forced through the membrane pores for about 15 minutes using a pump (this recirculation or forcing through is referred to as “forced permeation” for purposes of this Example B). Then the resulting membrane was soaked in a 50:50 mixture of intermediate solvent (100% isopropanol) and extraction solvent (100% commercial hexane) for 12 hours. After 6 hours this soaking included recirculation at a flow rate of 15 m³/hour per element and forced permeation for about 15 minutes. Finally, the resulting membranes were soaked in extraction solvent (100% commercial hexane) for 12 hours, also with recirculation and forced permeation of the extraction solvent at 6 hours for about 15 minutes with 15 m³/hour recirculation flow. The resulting membranes treated with this process are “conditioned membranes” for purposes of this Example B.

The soybean miscella containing about 75 wt. % hexane, 24.3 wt. % crude oil, and 0.7 wt. % phospholipids, was passed through the first conditioned membrane at a trans-membrane pressure of 4 Kgf/cm² at a rate of 0.6 m³/hour per element. The resulting retentate stream had about 7 wt. % phospholipids and 23 wt. % oil (i.e., the test was conducted at retentate concentration of 10× of the feed concentration). Excess hexane was added to this retentate in the proportion of 2 portions of hexane to 1 portion of retentate resulting in a stream containing 88 wt % hexane. This retentate stream was passed through a second conditioned membrane at a trans-membrane pressure of 4 Kgf/cm² at a rate of 0.35 m³/hour per element, resulting in a retentate stream having about 65 wt % hexane, 23 wt. % phospholipids and 12 wt. % oil which is equivalent to lecithin free of hexane with 66% acetone insolubles. This retentate stream was desolventized at a rate of 1800 kg/hour, 95° C. and 260 mmHg absolute pressure. The resulting concentration of hexane was 5%. The retentate stream was further desolventized at a temperature of 110° C. at an absolute pressure of 20 mm Hg and sparge steam of 80 kg/hour by using a stripper to produce 600 kg/hour of lecithin product with less than 5 ppm of hexane.

The food composition according to the invention shows reduced spattering when used for shallow frying. Shallow frying food products are defined as products used for frying wherein the food product to be fried is fried in a thin layer of the food composition of the present invention, i.e., the food product is not completely immersed in the food composition of the present invention. An example of shallow frying is frying of meat, fish or vegetables in a pan.

The food composition is supported by the following example. It should be understood that the example is not intended to limit the scope of the invention.

### EXAMPLE 1

The food composition was prepared in the following manner:

| Fat Phase: | | |
|---|---|---|
| Lecithin, membrane separated having a ratio of | 0.50 | wt. % |
| 2.4 of alkali metals to alkaline-earth metals | | |
| Distillated monoglycerides (emulsifier) | 0.30 | wt. % |
| Refined soybean oil | 46.80 | wt. % |
| Refined partially hydrogenated soybean oil | 31.20 | wt. % |
| Aqueous Phase: | | |
| NaCl | 1.10 | wt. % |
| Citric acid (anhydrous) | 0.11 | wt. % |
| Potassium sorbate (anhydrous) | 0.10 | wt. % |
| Tap water | 19.89 | wt. % |

The oils were mixed in a 1000 millimeter Pyrex® beaker using a mixer (Heldoph, Model RZR 2012, Germany) and placed in a 65° C. water bath. When the temperature of the fat phase reached about 60° C., the lecithin and monoglycerides were added to the mixture. The aqueous phase was prepared by mixing all the ingredients in a 800 millimeter Pyrex® beaker and heated to a temperature of 60° C. While mixing the fat phase at 1700 rpm, the aqueous phase was slowly added to the fat phase within one minute. The resulting emulsion was mixed at 1700 rpm for 2 minutes and then the speed was reduced to and maintained at 500 rpm with the temperature maintained at 60° C. A stainless steel container was put in a crushed ice and salt bath and cooled to below 0° C. Using a brush, a thin layer of the resulting emulsion was placed on the stainless steel container and crystallized to a hard margarine. This layering was repeated until about a 2millimeter layer was formed. The 2-millimeter layer was kept on the ice and salt bath (85/15 wt/wt %) for 10 minutes and then it was scraped off with a scraper and placed in a 1000 millimeter Pyrex® beaker. The steps of layering to form a 2-millimeter layer was repeated until a sufficient quantity of margarine was produced. The margarine was refrigerated at a temperature of 8° C. for 24 hours. After 24 hours, the margarine was kneaded using a mixer (Philips Creamix Deluxe, Model HR 1535) with two screw kneading units until the margarine had a smooth texture. The kneaded margarine was compacted by pushing down an 800 millimeter Pyrex® beaker in the 1000 millimeter Pyrex® beaker containing the margarine. The margarine was transferred to a non-transparent container with a lid and stored covered at 8° C. for up to 90 days.

The food composition according to the invention was evaluated for its spattering behavior shortly after the food composition was made (Day 0) and after a certain number of days after being stored at 8° C. (specifically, Days 1, 7, 14, 30, 45, 60 and 90). The following test procedure was used to determine a spattering value: 50 grams of the food composition was heated in a 24-centimeter diameter frying pan on an electric plate to about 205° C. The fat that spattered out of the pan by force of expanding evaporating water droplets was caught on a sheet of paper situated 30 centimeters above the frying pan.

TABLE 1

| | Day | Day | Day | Day | Day | Day | Day | Day |
|---|---|---|---|---|---|---|---|---|
| | 0 | 1 | 7 | 14 | 30 | 45 | 60 | 90 |
| Sample 1 | <10 | <10 | <10 | <10 | <10 | 45 | <10 | <10 |
| Sample 2 | <10 | <10 | <10 | <10 | <10 | 71 | <10 | <10 |

The results show that the sheet of paper caught less than 10 spatters of the food composition at Days 0, 1, 7, 14, 30, 60 and 90, which indicates the food composition of the present invention has desired frying characteristics in terms of spattering. It was observed that the number of spatters at Day 45 is inconsistent with the results obtained on the other days.

The invention has been described with reference to various specific and illustrative embodiments and techniques. However, one skilled in the art will recognize that many variations and modifications may be made while remaining within the spirit and scope of the invention.

We claim:

1. A food composition comprising oils and from about 0.05 wt. % to about 5.0 wt. % of a membrane separated lecithin having a ratio of alkali metals to alkaline earth metals ranging from greater than 0 to about 10.

2. The food composition of claim 1 further comprising from about 20 wt. % to about 100% wt. % fat phase and from greater than 0 wt. % to about 80 wt. % aqueous phase.

3. The food composition of claim 1 further comprising from about 30 wt. % to about 100 wt. % fat phase and from greater than 0 wt. % to about 70 wt. % aqueous phase.

4. The food composition of claim 1 further comprising from about 60 wt. % to about 90 wt. % fat phase and from about 10 wt. % to about 40 wt. % of aqueous phase.

5. The food composition of claim 1 wherein the membrane separated lecithin having a ratio of alkali metals to alkaline-earth metals ranges from greater than 0 wt. % to about 5 wt. %.

6. The food composition of claim 5 further comprising from about 20 wt. % to about 100% wt. % fat phase and from greater than 0 wt. % to about 80 wt. % aqueous phase.

7. The food composition of claim 5 further comprising from about 30 wt. % to about 100 wt. % fat phase and from greater than 0 wt. % to about 70 wt. % aqueous phase.

8. The food composition of claim 5 further comprising from about 60 wt. % to about 90 wt. % fat phase and from about 10 wt. % to about 40 wt. % of aqueous phase.

9. The food composition of claim 1 wherein the lecithin having a ratio of alkali metals to alkaline earth metals ranges from about 1.6 to about 3.0.

10. The food composition of claim 9 further comprising from about 20 wt. % to about 100% wt. % fat phase and from greater than 0 wt. % to about 80 wt. % aqueous phase.

11. The food composition of claim 9 further comprising from about 30 wt. % to about 100 wt. % fat phase and from greater than 0 wt. % to about 70 wt. % aqueous phase.

12. The food composition of claim 9 further comprising from about 60 wt. % to about 90 wt. % fat phase and from about 10 wt. % to about 40 wt. % of aqueous phase.

13. The food composition of claim 1 wherein the lecithin having a ratio of alkali metals to alkaline earth metals ranges from about 1.8 to about 2.8.

14. The food composition of claim 13 further comprising from about 20 wt. % to about 100% wt. % fat phase and from greater than 0 wt. % to about 80 wt. % aqueous phase.

15. The food composition of claim 13 further comprising from about 30 wt. % to about 100 wt. % fat phase and from greater than 0 wt. % to about 70 wt. % aqueous phase.

16. The food composition of claim 13 further comprising from about 60 wt. % to about 90 wt. % fat phase and from about 10 wt. % to about 40 wt. % of aqueous phase.
